(19) United States
(12) Patent Application Publication
(10) Pub. No.: US 2002/0147792 A1
(43) Pub. Date: Oct. 10, 2002

(54) Method and apparatus for configuring a portable computing device

(76) Inventors: Keith Alexander Harrison, Monmouthshire (GB); Richard Brown, Bristol (GB)

Correspondence Address: HEWLETT-PACKARD COMPANY, Intellectual Property Administration, P.O. Box 272400, Fort Collins, CO, 80527-2400, US

(21) Appl. No.: 10/096,290

(22) Filed: Mar. 12, 2002

(30) Foreign Application Priority Data
Mar. 24, 2001 (GB) 0107448.3

(51) Int. Cl. G06F 15/16

(52) U.S. Cl. 709/217; 709/226

(57) ABSTRACT

A method of informing the user of a portable computing device of the facilities available at an accommodation being visited, comprising compiling a list and communicating a copy of the list to the portable computing device, for example by use of a smart card readable by the portable computing device. The list preferably gives the location of the facilities, protocols for using the facilities and any digital permissions required to access the facilities. In another embodiment, the smart card may also provide access to a hotel room. In another embodiment, digital permissions may be timed to correspond to the duration of the visit.

### FIELD OF THE INVENTION

This invention relates to a method and apparatus for portable computing devices and, more particularly, to configuring a portable computing device for use in an accommodation being visited by the computing device user.

A portable computing device may, for example, be a laptop, a palmtop or a portable digital assistant, and will have an input means such as a keyboard or touch sensitive display, a CPU, ROM and RAM.

### BACKGROUND TO THE INVENTION

When a portable computing device user enters a new environment such as an hotel or an office, herein referred to as ‘accommodation’ for convenience, the accommodation will provide certain services some of which are computer based facilities available for use in conjunction with the portable computing device, such as printers, scanners, local area networks and Internet links. It is desirable to provide the portable computing device with information on the availability of these services, and preferably the location of such computer devices that may need to be visited by the user.

### SUMMARY OF THE INVENTION

According to one aspect of the invention a system and method of providing a user of a portable computing device of the facilities that are available at an accommodation comprising compiling a list of the facilities, and storing said list in memory storage, creating a copy of the list and communicating the copy to the portable computing device for reading by the portable computing device to enable the user to access the list via the portable computing device.

The copy of the list, in one embodiment, may be communicated to the portable computing device by temporarily establishing a communications link with the portable computing device by, for example, a cable connection or by a infra-red link such as an IrDA (Infrared Data Association) link, or the copy list may be provided on a record carrier, such as a floppy disc or a smart card, such as a PCMCIA (Personal Computer Memory International Association) card, the portable computing device being adapted to be loaded with the record carrier.

In another embodiment, the list preferably comprises the location of the facilities.

In another embodiment, the list may also comprise one or more digital permissions to enable the portable computing device to use the facilities by communication therewith.

The link could be established at a hotel or office reception desk, for example.

The release of the copy list to the portable computing device is preferably associated with a computerized checking-in facility, which is where the user is authenticated on arrival at the accommodation and agrees to the terms of use of the accommodation, such as the length of stay.

It is preferred that a checking-in computer performs the usual steps necessary to check-in the visitor before the copy list is provided to the visitor.

The copy list itself may not always be immediately communicated to the portable computing device. In another embodiment, the instruction provided to the portable computing device contains an address, such as a URL (Uniform Resource Locator), which is accessed by the portable computing device in order to obtain or gain access to the list.

The facilities for use by the visitor may comprise computer facilities that can be linked to the portable computing device. The list preferably provides details of such on-site devices.

It may often be necessary to configure the portable computing device for communication with such on-site devices according to the appropriate protocols.

Preferably, the copy list is provided with configuration instructions which can be implemented by the portable computing device to configure the portable computing device for use with one or more of the devices.

According to another embodiment of the invention a system and method for temporarily configuring portable computing devices visiting a location to interface with a static computing facility provided at the location, the facility comprising a plurality of on-site devices, the method comprising compiling a list of the devices and associated protocols for interfacing with the respective devices along with instructions as to the physical location of such devices that may need to be visited in use, storing said list in memory storage and then creating a copy of the list on a record carrier which is capable of being read by the portable computing device, issuing an individual record carrier to the visitor, the portable computing device subsequently being loaded with the record carrier, and at least some of the configuration instructions provided on the record carrier being executed by the portable computing device so as to configure the portable computer for interfacing with one or more of the devices.

The record carrier may also be capable of unlocking a room or cabinet door. For example, if the record carrier is a smart card, the room door lock may be arranged to be released on insertion of the smart card into a smart card reader slot provided in a housing on the door or adjacent thereto.

It may be arranged that as part of the checking-out procedure from the accommodation the record carrier is returned to the checking-out facility.

The copy list which is supplied to the portable computing device preferably comprises an identifier of the visitor, and the computer facilities made available to the visitor during his or her stay. Some of those facilities require an authentication procedure to be performed with the portable computing device which involves the supply of the identifier by the portable computing device.

The availability of the facilities to the visitor may be time restricted, for example by providing a smart card with a timing function and pre-set validity period. When digital permissions, such as a password, are required to be furnished to the facilities to gain access to the facilities, these permissions may be time-restricted by a timing function of the smart card.

Alternatively, the facilities may be supervised by a managing computer which is arranged to bar use of the facilities by the visitor after a pre-set period. The managing computer is preferably a checking-in facility.

According to another embodiment of the invention an accommodation checking-in computer facility arranges to release to a visitor, when the visitor has complied with a checking-in procedure, a set of instructions for accessing by a portable computing device which accompanies the visitor.

Preferably at least some of the instructions are executable on the portable computing device.

### BRIEF DESCRIPTION OF THE DRAWINGS

An understanding of the invention may be gained from the following description of some examples of embodiments of the invention, with reference to the accompanying drawings, in which:

FIG. 1 is a schematic perspective view of a laptop computer;

FIG. 2 is a block diagram of a hotel checking-in and checking-out computer facility incorporating a smart card writer; and

FIG. 3 is a typical list of computer devices capable of being addressed by the visitor's laptop.

### DETAILED DESCRIPTION OF THE PREFERRED EMBODIMENT

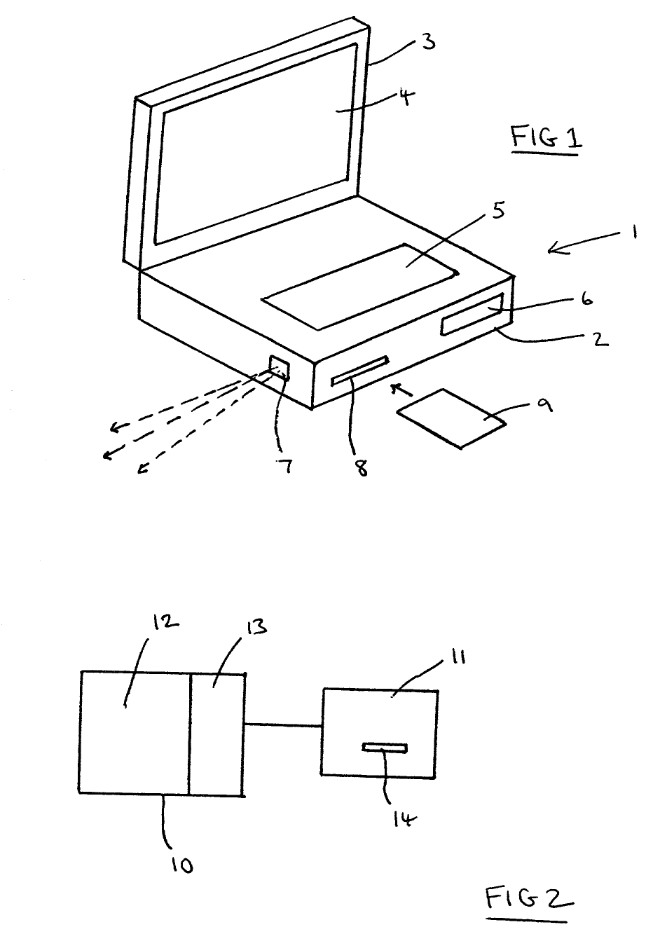

The exemplary laptop of FIG. 1 is of conventional construction in comprising a main housing 2, a pivoted lid 3 provided with a display 4, a keyboard 5 mounted on the housing 2, a disc drive 6, and an infra-red communicator 7.

In addition the laptop 1 is provided with a smart card reader behind smart card slot 8 into which a smart card 9 can be inserted.

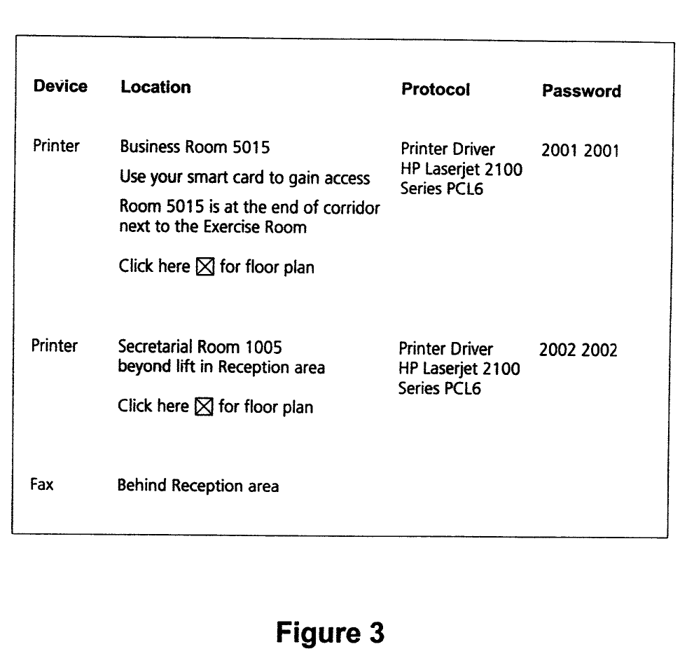

FIG. 2 indicates a hotel checking-in and checking-out computer 10 linked to a smart card writer 11. The computer 10 utilizes software in module 12 to control the usual checking-in functions performed by such a computer facility: recording room number allocated to the visitor, visitor's company name, time and date of arrival, intended time of departure, agreed room rate, any special requirements, etc. Once the hotel receptionist, or the computer module 12, is satisfied that the visitor's details have been sufficiently recorded in module 12, an instruction is provided by module 12 to a hotel facilities store 13 to provide the writer 11 with a set of hotel facility service information, such as the set shown in FIG. 3. The set of services may be tailored to the category of hotel room stored in unit 12, or to the package of hotel facilities requested by the visitor and stored in unit 12.

On insertion of a prepared smart card 9 into the reader slot 14 the smart card is loaded with the requisite data, as will be discussed below.

A smart card, which may be a Java card, for example, has been previously prepared from its uncommitted state by an administrator who would issue an associated administrator pin number which is subsequently required to be proffered in order to unlock the card and allow data to be loaded onto the card. One such embodiment is a card is written in Java. The smart card writer 11 is provided with the administrator pin number to enable the writer 11 to unlock the card inserted into slot 14, and to load the card with the requisite data corresponding, for example, to the list of FIG. 3. In addition the computer 10 issues a user pin number which is loaded into a protected user pin number storage location of the card.

On completion of the writing process to the smart card, the card is removed from the writer slot 14. Removal of external power from the card will result in re-locking of the card. The card is given to the visitor along with details of the user pin number.

In order to access the list on the card the visitor inserts the smart card 9 into the smart card slot 8 of laptop 1 when requested, by for example a browser pop-up, and supplies the user pin number by use of keyboard 5.

In the circumstance that the smart card 9 is used to release a door lock, by insertion of the smart card into a door card reader, then the door card reader may be arranged to supply the user pin number on insertion of the card into the door card reader, in order to confirm the identity of the card.

The card then provides a door-lock release authorisation signal to the door locking mechanism in well-known manner, to enable the door handle to be turned to open the room door.

The list of available hotel services of FIG. 3 might also be modified to include, for example, the following additional permissions:

a) The URL for the hotel to allow the visitor to connect to the hotel administrative system in order, for example, to look at the current status of the hotel bill,

b) The URL and password for accessing the hotel group booking system.

Therefore, having thus described the invention, at least the following is claimed:

1. A method of providing a portable computing device access to a plurality of facilities available at an accommodation, the method comprising the steps of:
compiling a list of the facilities; and
communicating the list to the portable computing device to allow a user access to the facilities via the portable computing device.

2. The method of claim 1, wherein the list comprises at least a location for each one of the plurality of facilities.

3. The method of claim 2, further comprising the step of temporarily establishing a communications link with the portable computing device such that the list is communicated to the portable computing device.

4. The method of claim 3, further comprising the step of establishing the communications link at an accommodation reception desk.

5. The method of claim 1, further comprising the step of authenticating the user on arrival at the accommodation with a computerized checking-in facility, and wherein the step of communicating the list to the portable computing device is completed after the step of authenticating.

6. The method of claim 5, further comprising the step of checking-in the user with a checking-in computer before the list is communicated to the portable computing device.

7. The method of claim 1, further comprising the step of storing the list on a record carrier such that the list is provided to the user via the record carrier.

8. The method of claim 7, wherein the record carrier is a smart card.

9. The method of claim 1, further comprising the step of providing an instruction to the portable computing device, the instruction comprising at least an address such that the portable computing device accesses the address so that the step of communicating the list is performed.

10. The method of claim 1, wherein the facilities comprise at least one computer device, and further comprising the step of linking at least one computer device to the portable computing device such that the linked computer device is used by the user.

11. The method of claim 10, further comprising the step of providing at least one configuration instruction, the configuration instruction residing in the list, and wherein the configuration instruction is configured to be implemented by the portable computing device such that the portable computing device is configured for use with at least one of the computing devices.

12. The method of claim 10, wherein the list comprises at least one digital permission, the digital permission configured to authorize access to at least one of the computing devices by the portable computing device.

13. The method of claim 12, wherein at least one of the digital permissions is a time-restricted permission.

14. The method of claim 13, further comprising the step of timing the time-restricted permission by a managing computer configured to bar access to the facilities by the portable computing device after a pre-set period.

15. The method of claim 1, further comprising the step of establishing a communications link with the portable computing device such that the list is communicated to the portable computing device.

16. A method of temporarily configuring portable computing devices visiting a location to interface with a static computing facility provided at the location, the facility comprising a plurality of on-site devices, the method comprising the steps of:
compiling a list of the on-site devices and associated protocols for interfacing with the respective on-site devices;
compiling a list of instructions corresponding to the physical location of the on-site devices; and
creating a copy of the list of the on-site devices and instructions on a record carrier, the record carrier configured to be readable by the portable computing device and comprised of at least one configuration instruction.

17. The method of claim 16, further comprising the steps of:
issuing the record carrier to the user;
loading the record carrier into the portable computing device; and
executing the configuration instruction by the portable computing device such that the portable computing device is configured to interface with at least one of the on-site devices.

18. The method of claim 16, wherein the record carrier is further configured to unlock a door when the record carrier is inserted into a reader slot coupled to the door.

19. The method of claim 18, wherein the record carrier is a smart card and the reader slot is a smart card reader slot configured to communicatively receive the smart card.

20. The method of claim 16, further comprising a checking-out procedure that includes the step of returning the record carrier to a checking-out facility.

21. A system for checking-in visitors at an accommodation having at least one computer device, the system comprising:
an accommodation checking-in computer facility configured to facilitate a checking-in procedure such that a visitor is checked into the accommodation; and
a set of instructions configured to provide access to a portable computing device which accompanies the visitor, such that the set of instructions is communicated to the visitor during the checking-in procedure.

22. The system of claim 21, wherein at least one of the instructions is executable on the portable computing device.

23. The system of claim 21, further comprising a record carrier, the record carrier configured to store the set of instructions, and further configured to communicate the set of instructions to the portable computing device.

24. The system of claim 23, wherein the record carrier is a smart card configured to communicatively couple with a smart card reader slot, the smart card reader slot residing in the portable computing device.

25. The system of claim 24, wherein the smart card is further configured to communicatively couple with a second smart card reader slot, the second smart card reader slot coupled to a door lock on a door, such that the set of instructions releases the door lock.

26. The system of claim 23, further comprising a checking-out facility configured to facilitate a checking-out procedure such that the record carrier is returned during the checking-out procedure.
